(19) United States
(12) Patent Application Publication
(10) Pub. No.: US 2013/0260679 A1
(43) Pub. Date: Oct. 3, 2013

(54) NEAR-FIELD WIRELESS COMMUNICATION CONNECTION METHOD

(71) Applicants: AIBELIVE CO., LTD., Taipei City (TW); FLYFISH HOLDINGS LIMITED, British Virgin Island (GB)

(72) Inventors: Chen-Wei SU, Taipei City (TW); Chun-Ping FANG, Taipei City (TW)

(73) Assignees: FLYFISH HOLDINGS LIMITED, British Virgin Islands (GB); AIBELIVE CO., LTD., Taipei City (TW)

(21) Appl. No.: 13/777,826

(22) Filed: Feb. 26, 2013

(30) Foreign Application Priority Data
Mar. 27, 2012 (TW) 101110603

(51) Int. Cl. H04B 5/00

(52) U.S. Cl. CPC H04B 5/00
USPC 455/41.1

(57) ABSTRACT

A near-field wireless communication connection method for allowing communication between a handheld device and an electronic device via a wireless access point includes the steps: a first non-contact sensor chip of a first NFC module of the electronic device converts a pre-stored connection data containing the name of the wireless access point, password, encryption and information of the electronic device into a wireless signal for enabling a first antenna of the electronic device to transmit the wireless signal to a second antenna of a second NFC module of the handheld device so that a second non-contact sensor chip of the second NFC module can convert the wireless signal back to the original connection data for enabling a processor of the handheld device to connect to the wireless access point using the connection data and to further communicate with the electronic device.

This application claims the priority benefit of Taiwan patent application number 101110603, filed on Mar. 27, 2012.

### BACKGROUND OF THE INVENTION

1. Field of the Invention

The present invention relates to wireless communication technology and more particularly, to a near-field wireless communication connection method, which enables the name of the wireless access point, password, encryption and information of an electronic device to be provided to a handheld device wirelessly by means of near field communication modules the handheld device can establish communication with the electronic device via the wireless access point, avoiding communication problem between the handheld device and the electronic device due to forgotten connection data and facilitating quick connection.

2. Description of the Related Art

Continuous functional improvement of handheld devices brings great convenience to human life. Under the rapid pace of life today, in case of an emergency, one person can communicate with another at a remote place using a handheld device. Further, most people may suffer from lack of time in life. Many people may travel abroad frequently due to their job nature or work environment. Under these conditions, manufacturers keep creating telecommunication network technology for handheld devices. Nowadays, 3G and 4G networks have been available, allowing people to talk anywhere via a handheld device, to send a short message through a handheld device, or to connect a handheld device to the Internet.

Further, the widespread use of smart phone encourages creation of a variety of application software programs. You can see handheld devices doing different things in different places in our life. These smart phone application software programs allow connection to the Internet. Thus, people can use a handheld device to send e-mails, communicate with friends, search web data or record things when taking a transportation vehicle, walking or waiting for a bus. Further, when going outside, people can use a handheld device to query a search engine to get route, transportation, restaurant, movie, exhibition and many other information or data. However, due to network bandwidth limitations, the flow rate is constrained. Providers need to spend a lot of time and capital to upgrade their installations regularly. Users may frequently encounter the problem of low internet speed or internet traffic jams.

Nowadays, internet access technology for computer has been changed from early Ethernet cable connection to modern wireless connection through a wireless access point. A wireless access point allows a handheld device to connect to the internet or to communicate with other internet devices wirelessly without any network cable line. Wireless access points have been established everywhere around us. Due to the advent of wireless internet connections and wireless access points, people may use a handheld device at a particular place (office, home, transportation station, etc.) to connect to a wireless access point for high speed internet transmission. However, when using a handheld device at a different place, the name of the wireless access point, password and encryption may be changed. In this case, the user shall have to manually alter the settings of the handheld device for wireless network operation. If the user cannot remember the related connection data, wireless network operation will not work. Further, when using a handheld device to connect to a computer through a wireless network, an extra setting operation is necessary. This setting operation is complicated, bothering the user. If the user is not familiar with this setting operation, the connection cannot be achieved. Improvement in this regard is strongly desired.

### SUMMARY OF THE INVENTION

The present invention has been accomplished under the circumstances in view. It is therefore the main object of the present invention to provide a near-field wireless communication connection method, which allows wireless communication between a handheld device and an electronic device via a wireless access point, avoiding communication problem between the handheld device and the electronic device due to forgotten connection data and facilitating quick connection.

To achieve this and other objects of the present invention, a near-field wireless communication connection method includes the steps: the first non-contact sensor chip of the first NFC module of the electronic device converts a pre-stored connection data containing the name of the wireless access point, password, encryption and information of the electronic device into a wireless signal for enabling the first antenna of the electronic device to transmit the wireless signal to the second antenna of the second NFC module of the handheld device so that the second non-contact sensor chip of the second NFC module can convert the wireless signal back to the original connection data containing the name of the wireless access point, password, encryption and information of the electronic device for enabling the processor of the handheld device to connect to the wireless access point using the connection data and to further communicate with the electronic device. As the user does not need to remember or key in the connection data, wireless communication between the handheld device and the electronic device can be performed conveniently and rapidly.

Further, the near-field wireless communication connection method further includes a first sub step after the processor of the handheld device received the connection data where the processor of the handheld device determines the current operation mode to be an auto (active) connection mode or manual (passive) connection mode, and then the processor connects to the wireless access point if the current operation mode is an au auto (active) connection mode. If the current operation mode is a manual (passive) connection mode, the screen of the handheld device displays “access point name” column and “password” column for manual input for enabling the processor to connect to the wireless access point through the wireless transceiver module subject to the keyed-in data and the encryption contained in the connection data. Thus, the processor of the handheld device can communicate with the electronic device by means of the wireless transceiver module and the wireless access point subject to the information of the electronic device contained in the connection data.

### BRIEF DESCRIPTION OF THE. DRAWINGS

FIG. 1 is a circuit block diagram of a near-field wireless communication connection method in accordance with the present invention.

FIG. 2 is an operational flow chart of the near-field wireless communication connection method in accordance with the present invention (I).

FIG. 3 is an operational flow chart of the near-field wireless communication connection method in accordance with the present invention (II).

FIG. 4 is a perspective view of an electronic device used in the near-field wireless communication connection method in accordance with the present invention.

FIG. 5 is an exploded view of a handheld device used in the near-field wireless communication connection method in accordance with the present invention.

FIG. 6 is a schematic drawing illustrating an application example of the near-field wireless communication connection method in accordance with the present invention.

### DETAILED DESCRIPTION OF THE PREFERRED EMBODIMENT

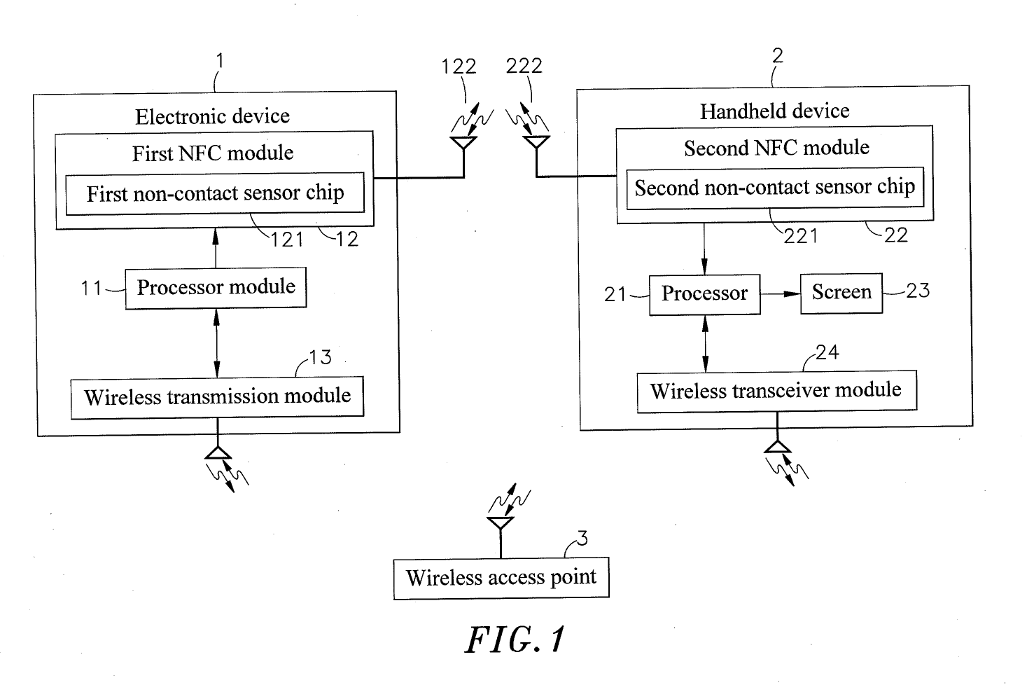

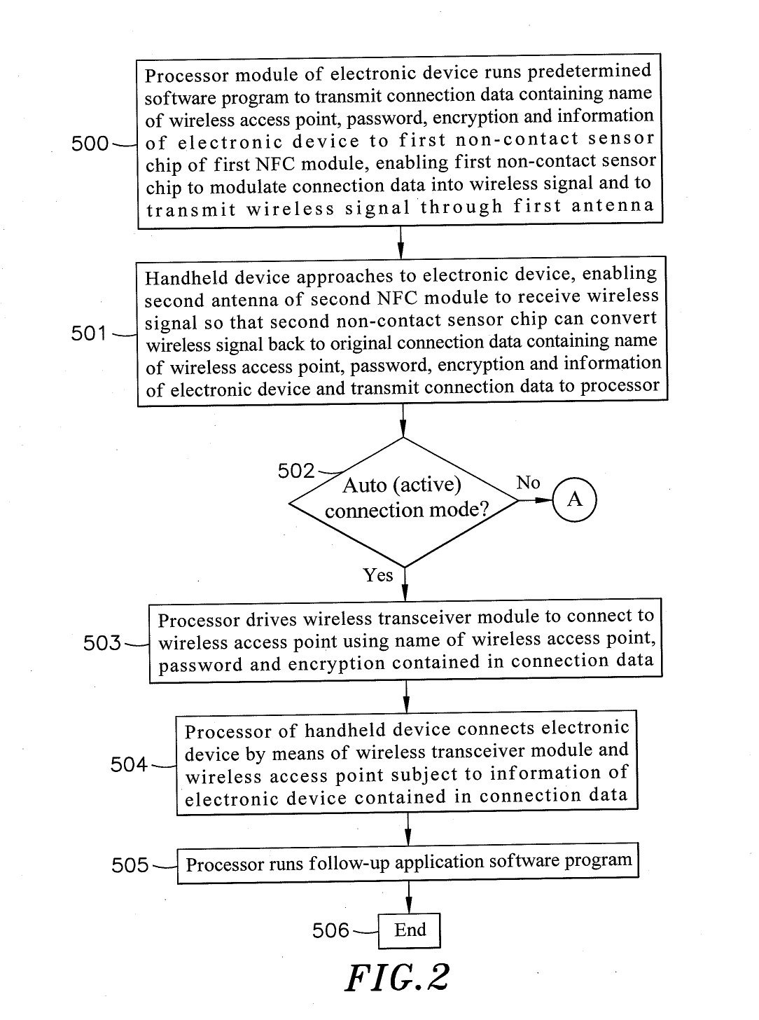

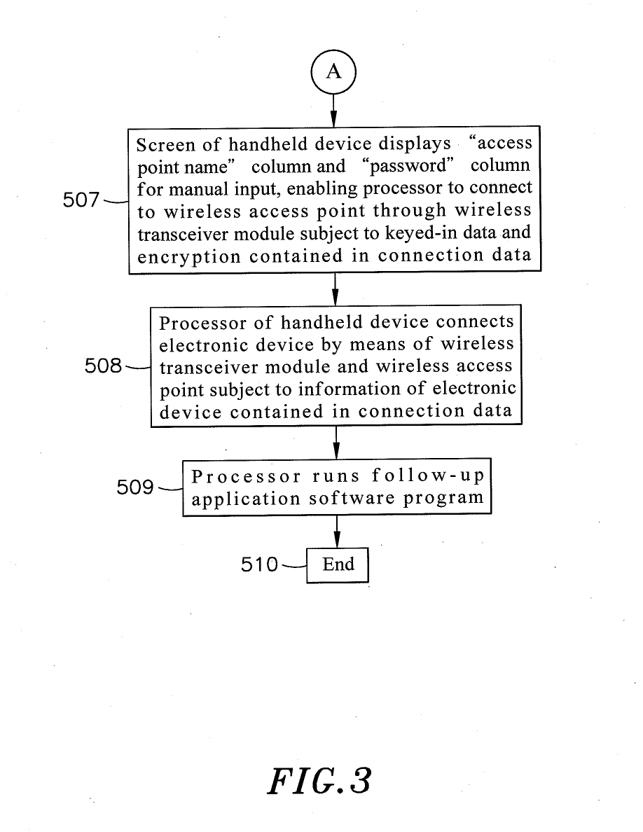

Referring to FIGS. 1-3, a near-field wireless communication connection method in accordance with the present invention is adapted for allowing wireless communication between an electronic device 1 and a handheld device 2 via a wireless access point 3.

The electronic device 1 comprises a processor module 11, a first NFC (near field communication) module 12 and a wireless transmission module 13. The first NFC module 12 and the wireless transmission module 13 are respectively electrically coupled to the processor module 11. The first NFC module 12 comprises a first non-contact sensor chip 121 and a first antenna 122 electrically connected to the first non-contact sensor chip 121.

The handheld device 2 comprises a processor 21, a second NFC (near field communication) module 22, a screen 23, and a wireless transceiver module 24. The second NFC module 22, the screen 23 and the wireless transceiver module 24 are respectively electrically coupled to the processor 21. The second NFC module 22 comprises a second non-contact sensor chip 221 and a second antenna 222 electrically connected to the second non-contact sensor chip 221.

The wireless access point 3 can be linked with the wireless transmission module 13 of the electronic device 1 and the wireless transceiver module 24 of the handheld device 2 wirelessly. The structural design of component parts of the wireless access point 3 and its wireless linking method are of the known art, no further detailed description in this regard will be necessary.

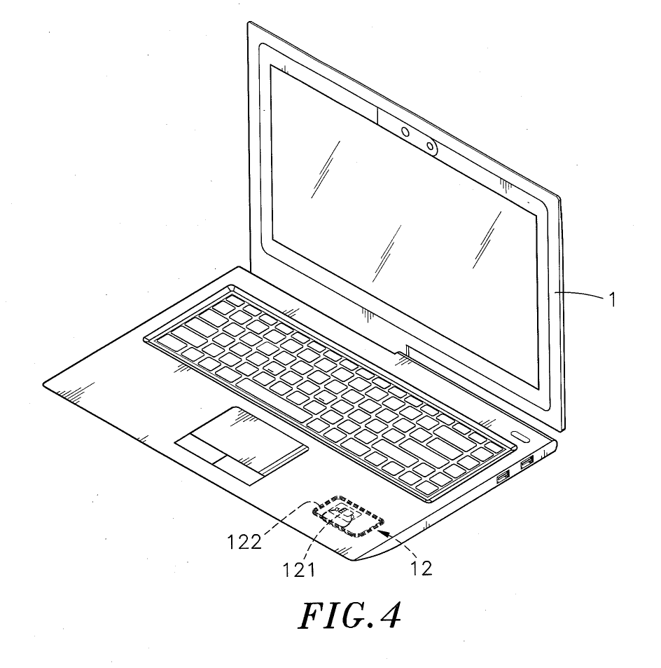

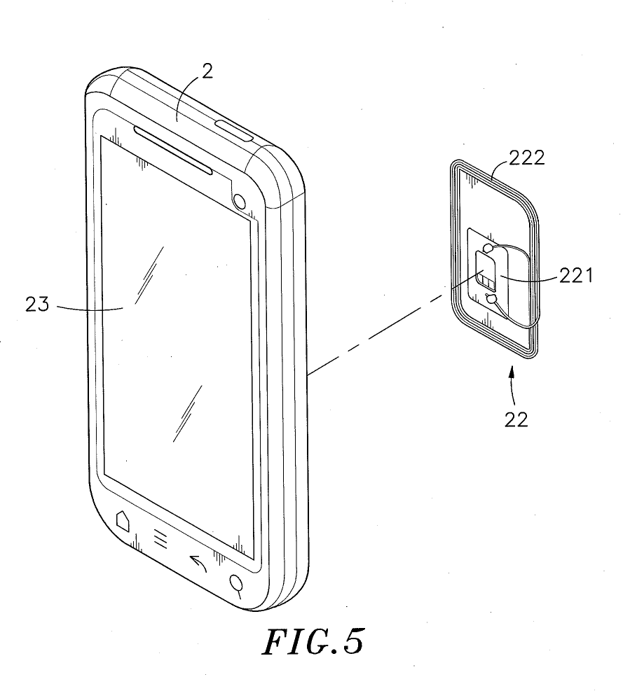

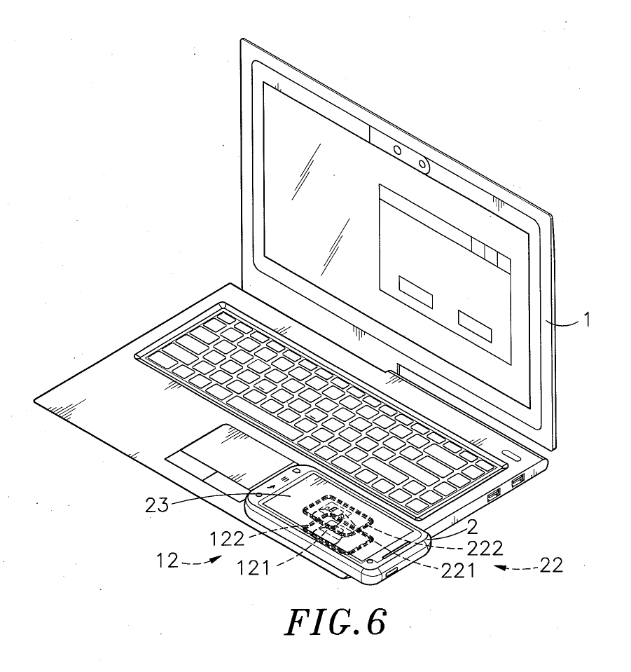

Referring to FIGS. 4-6 and FIGS. 1-3 again, when the electronic device 1, the handheld device 2 and the wireless access point 3 are started, the handheld device 2 can be connected to the telecommunication network by means of the wireless transceiver module 24, and the electronic device 1 can be connected to the wireless access point 3 by means of the wireless transmission module 13. At this time, the wireless transceiver module 2 can be communicated with the electronic device 1 by means of near field communication subject to the following steps:
(500) The processor module 11 of the electronic device 1 runs a predetermined software program to transmit a pre-stored connection data containing the name of the wireless access point 3, password, encryption and information of the electronic device 1 to the first non-contact sensor chip 121 of the first NFC module 12, enabling the first non-contact sensor chip 121 to modulate the connection data into a wireless signal and to let the wireless signal be transmitted wirelessly through the first antenna 122.
(501) The handheld device 2 is kept close to the electronic device 1, enabling the second antenna 222 of the second NFC module 22 to receive the wireless signal transmitted by the electronic device 1 so that the second non-contact sensor chip 221 can convert the wireless signal back to the original connection data containing the name of the wireless access point 3, password, encryption and information of the electronic device 1 and transmit the connection data to the processor 21.
(502) The processor 21 of the handheld device 2 determines whether or not the current operation mode is an auto (active) connection mode. And then, the processor 21 proceeds to step (503) if positive, or step (507) if negative.
(503) The processor 21 drives the wireless transceiver module 24 to connect to the wireless access point 3 using the name of the wireless access point 3, password and encryption contained in the received connection data.
(504) The processor 21 of the handheld device 2 connects to the electronic device 1 by means of the wireless transceiver module 24 and the wireless access point 3 subject to the information of the electronic device 1 contained in the received connection data.
(505) The processor 21 of the handheld device 2 runs the follow-up application software program.
(506) End.
(507) The screen 23 of the handheld device 2 displays “access point name” column and “password” column for manual input, enabling the processor 21 to connect to the wireless access point 3 through the wireless transceiver module 24 subject to the keyed-in data and the encryption contained in the connection data.
(508) The processor 21 of the handheld device 2 connects to the electronic device 1 by means of the wireless transceiver module 24 and the wireless access point 3 subject to the information of the electronic device 1 contained in the connection data.
(509) The processor 21 of the handheld device 2 runs the follow-up application software program.
(510) End.

From the steps described above, it can be known that, prior to connection between the electronic device 1 and the handheld device 2 by near field communication, the handheld device 2 is connected to the telecommunication network by means of the wireless transceiver module 24, and the electronic device 1 is connected to the wireless access point 3 by means of the wireless transmission module 13. The method of connecting the handheld device 2 to the telecommunication network and the method of connecting the electronic device 1 to the wireless access point 3 are of the known art and not within the scope of the present invention, and hence no further detailed description in this regard will be necessary. At this time, the electronic device 1 and the wireless access point 3 cannot connect the telecommunication network, and therefore, the handheld device 2, the electronic device 1 and the wireless access point 3 are not linked. At this time, the processor module 11 of the electronic device 1 can be controlled to run a predetermined software program, transmitting a pre-stored connection data containing the name of the wireless access point 3, password, encryption and information of the electronic device 1 to the first non-contact sensor chip 121 of the first NFC module 12, which in turn, modulates the connection data into a wireless signal and transmits the wireless signal through the first antenna 122.

At this time, the user needs only to approach the handheld device 2 to the electronic device 1. When approaching the handheld device 2 to the electronic device 1, the second antenna 222 of the second NFC module 22 will receive the wireless signal transmitted by the electronic device 1. After receipt of the wireless signal by the antenna 222, the second non-contact sensor chip 221 immediately converts the wireless signal back to the original connection data and transmits the connection data to the processor 21. Thereafter, the processor 21 determines the operation mode to be an auto (active) connection mode or manual (passive) connection mode. In case of auto (active) connection mode, the handheld device 2 connects to the wireless access point 3 subject to the name of the wireless access point 3, password and encryption contained in the received connection data. In case of manual (passive) connection mode, the screen 23 of the handheld device 2 will display “access point name” column and “password” column for manual input, enabling the processor 21 to connect to the wireless access point 3 through the wireless transceiver module 24 subject to the keyed-in data and the encryption contained in the connection data. When the handheld device 2 and the wireless access point 3 are linked, the processor 21 of the handheld device 2 connects the electronic device 1 by means of the wireless transceiver module 24 and the wireless access point 3 automatically subject to the information of the electronic device 1 contained in the connection data. At this time, the handheld device 2 enters the domain of the electronic device 1. Thereafter, the processor 21 runs the follow-up application software program, allowing transmission of data or instructions between the electronic device 1 and the handheld device 2.

Further, the aforesaid electronic device 1 can be a desk computer, TV, tablet computer or notebook. The handheld device 2 can be a cell phone, smart phone, PDA, tablet computer, or any of a variety of mobile communication device. Further, the telecommunication network connected by the handheld device 2 can be 3G network or 4G network.

During actual application of the present invention, the user can use the handheld device 2 to receive the wireless signal transmitted by the first NFC module 12 of the electronic device 1 and to convert the wireless signal back to the original connection data that contains the name of the wireless access point 3, password, encryption and information of the electronic device 1, and thus the handheld device 2 can get the connection data directly and the user needs not to input the name of the wireless access point 3, password, encryption and information of the electronic device 1 into the handheld device 2, avoiding communication problem between the handheld device 2 and the electronic device 1 due to forgotten connection data, and facilitating quick connection.

Further, after the second non-contact sensor chip 221 converts the wireless signal back to the original connection data and transmits the connection data to the processor 21, the processor 21 determines the operation mode to be an auto (active) connection mode or manual (passive) connection mode. In case of auto (active) connection mode, the handheld device 2 will connect to the wireless access point 3 subject to the name of the wireless access point 3, password and encryption contained in the connection data. In case of manual (passive) connection mode, the screen 23 of the handheld device 2 will display “access point name” column and “password” column for manual input. After manual input of the related data, the processor 21 will connect to the wireless access point 3 subject to the inputted data, and then communicate with the electronic device 1 via the wireless access point 3. Because different brands, models or types of handheld devices 2 have different internal systems and setting methods, the invention employs the step of determining the operation mode to an auto (active) connection mode or manual (passive) connection mode, enabling different brands, models or types of handheld devices 2 to be connectable to the electronic device 1 via the wireless access point 3. Thus, even a handheld device simply provides a manual (passive) connection mode, it can still automatically catch the necessary connection data to establish connection with the electronic device.

In conclusion, the invention provides a near-field wireless communication connection method for allowing communication between a handheld device 2 and an electronic device 1 via a wireless access point 3, wherein, the first non-contact sensor chip 121 of the first NFC module 12 of the electronic device 1 converts a pre-stored connection data containing the name of the wireless access point 3, password, encryption and information of the electronic device 1 into a wireless signal, enabling the first antenna 122 to transmit the wireless signal to the second antenna 222 of the second NFC module 22 so that the second non-contact sensor chip 221 of the second NFC module 22 can convert the wireless signal back to the original connection data containing the name of the wireless access point 3, password, encryption and information of the electronic device 1 for enabling the processor 21 to connect to the wireless access point 3 using the connection data and to further communicate with the electronic device 1.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A near-field wireless communication connection method for allowing wireless communication between an electronic device and a handheld device via a wireless access point, wherein said electronic device comprises a processor module, a first NFC (near field communication) module comprising a first non-contact sensor chip and a first antenna and a wireless transmission module; said handheld device is connected to a telecommunication network, comprising a processor, a second NFC (near field communication) module comprising a second non-contact sensor chip and a second antenna, a screen, and a wireless transceiver module, the near-field wireless communication connection method comprising the steps of:
(A01) said processor module of said electronic device running a predetermined software program to transmit a pre-stored connection data containing the name of said wireless access point, password, encryption and information of said electronic device to said first non-contact sensor chip of said first NFC module for enabling said first non-contact sensor chip to modulate said connection data into a wireless signal and to send out said wireless signal wirelessly through said first antenna;
(A02) approaching said handheld device to said electronic device to enable said second antenna of said second NFC module to receive said wireless signal being transmitted by said electronic device and to let said second non-contact sensor chip convert said wireless signal back to the original said connection data containing the name of said wireless access point, said password, said encryption and said information of said electronic device and then transmit said connection data to said processor;
(A03) said processor of said handheld device driving said wireless transceiver module to connect to said wireless access point using the name of said wireless access point, said password and said encryption contained in said connection data;
(A04) said processor of said handheld device connecting said electronic device by means of said wireless transceiver module and said wireless access point subject to said information of said electronic device;
(A05) said processor of said handheld device running the follow-up application software program; and
(A06) ending the operation.

2. The near-field wireless communication connection method as claimed in claim 1, further comprising a first sub step performed after step (A02) and prior to step (A03) where said processor of said handheld device determines the current operation mode to be an auto (active) connection mode or manual (passive) connection mode, and then said processor proceeds to step (A03) if the current operation mode is an au auto (active) connection mode, or a second sub step, if the current operation mode is a manual (passive) connection mode, where said screen of said handheld device displays “access point name” column and “password” column for manual input for enabling said processor to connect to said wireless access point through said wireless transceiver module subject to the keyed-in data and the encryption contained in said connection data, so that said processor of said handheld device connects said electronic device by means of said wireless transceiver module and said wireless access point subject to said information of said electronic device contained in said connection data before proceeding to step (A05).

3. The near-field wireless communication connection method as claimed in claim 1, wherein said electronic device is selected from the group of desk computers, televisions, tablet computers and notebook computers.

4. The near-field wireless communication connection method as claimed in claim 1, wherein said handheld device is selected from the group of mobile phones, smart phones, PDAs and tablet computers; said telecommunication network is one of 3G and 4G networks.
